(19) United States
(12) Patent Application Publication
(10) Pub. No.: US 2010/0194051 A1
(43) Pub. Date: Aug. 5, 2010

(54) BELT DISCHARGER

(76) Inventors: Andreas Gramer, Solingen (DE); Holger Behrens, Erkrath (DE); Matthias Kretschmer, Koeln (DE); Ralf-Hartmut Sohl, Solingen (DE); Peter De Kock, Oberhausen (DE); Lutz Kuemmel, Juechen (DE)

Correspondence Address: KF ROSS PC, 5683 RIVERDALE AVENUE, SUITE 203 BOX 900, BRONX, NY, 10471-0900, US

(21) Appl. No.: 12/446,464

(22) PCT Filed: Oct. 18, 2007
(86) PCT No.: PCT/EP07/09009

§ 371 Date: Apr. 21, 2009

(30) Foreign Application Priority Data
Oct. 27, 2006 (DE) 10 2006 051 397.5
Mar. 1, 2007 (DE) 10 2007 009 992.6

(51) Int. Cl. F16J 15/16

(52) U.S. Cl. 277/345

(57) ABSTRACT

The invention relates to a belt discharger (1) for sealing a first space (2) with respect to a second space (3), the two spaces (2, 3) being passed by a belt (4), especially a metal belt, the spaces (2, 3) being sealed through provision of at least two rollers (5, 6) which adjoin the belt (4) with sealing on both sides. In order to achieve improved sealing action, the invention envisages that at least one roller (5, 6), in one of its axial end regions (7), has a sealing element (8) which is designed to laterally adjoin the belt edge (9) of the belt (4), with provision of adjustment means (10) with which the roller (5, 6) including sealing element (8) can be positioned in axial direction (a).

The invention relates to a strip-sealing gate for sealing a first space relative to a second space through both of which passes a strip, in particular a metal strip, at least two rollers provided for sealing the spaces engaging the strip on both faces thereof.

In the production and treatment of a metal strip, particularly a steel strip, it is on occasion necessary to carry out processes under subatmospheric pressure (vacuum process). To this end, the strip is conveyed into a space having a reduced pressure relative to environmental pressure. For continuous operation, strip-sealing gates of the above-mentioned type are required that seal against the strip between the spaces having different pressures. The gates thus primarily serve for creating a pressure differential between two adjacent strip-treatment zones.

Standard strip-sealing gates are known, for example, from DE 44 18 383, and DE 199 60 751 that describe how two seal rollers engage the strip in order to seal around it at the gate, with a first seal roller on the upper face and a second seal roller on the lower face of the strip. In order to improve the sealing action of the gate the cylindrical rollers are have jackets made of an elastic, flexible material forming their outer surfaces. The jacket may be engage the strip surface in a sealing manner, thus increasing the sealing action of the gate.

Such strip-sealing gates are generally used for products having a width/thickness ratio substantially greater than 1. They may also be used to seal chambers against each other, in which different media are used for the strip treatment.

The known solutions do not always operate in a completely satisfying manner. This is true in particular if the width of the strip to be sealed changes due to the workpiece being processed. Adjustment of the strip-sealing gate to strips of different width is difficult and does not always produce a good sealing result.

The object of present invention is therefore to further improve a strip-sealing gate of the above-mentioned type such that an improvement can be achieved in this regard. The gate should have improved sealing action and should be usable for strips having widely different widths and thicknesses.

The object is achieved by the invention in that at least one of the rollers has at one of its axial ends a seal configured to laterally engage an edge of the strip, positioning means being provided that can shift the roller and the seal parallel to the roller axis.

It is possible with this embodiment of the strip-sealing gate to axially position the roller and including the seal such that the transition from the roller to the seal exactly engages a strip edge. The seal can then laterally contact the strip edge and thus seals against it. In this manner an improved sealing effect can be achieved, particularly at the strip edge, where a “space” always remains unsealed according to the prior art.

In this manner it is possible to substantially improve the sealing capability of the strip-sealing gate in the critical area of the strip edges.

Preferably, both rollers are equipped with seal at their axially opposite ends.

To this end, the seal is preferably a seal roller. In this case the seal roller consists at least partially of a flexible, elastic material. The seal roller at the axial end of the roller may be supported by a rocker biased by a spring.

An alternate embodiment provides that the seal is a seal plate. In this case the seal plate is positioned for engaging the end face of the opposite roller.

A further improvement provides for further good sealing action in that a seal is provided on the roller, preferably above or below the roller. The seal may be formed as a seal strip. As an alternative, it may also be formed as a seal roller.

The invention may provide for the efficient sealing of an upstream in that the at least one roller engages at least one seal roller that is arranged on the same strip face. To this end, the seal roller may engage yet another seal roller. At least one of the seal rollers may engage a sealing surface. To this end, it is preferred that the sealing surface be of a concave shape to which the contacting seal roller fits complementarily.

In order to build up higher pressure differentials, it has been proven effectively to arrange a number of gates successively in the strip travel direction.

The strip-sealing gate is preferably used in order to serve for sealing a first space having a first pressure relative to a second space having a second pressure deviating from the first pressure. However, it may also be used at equal pressure of the spaces, if different media are to be sealed relative to each other in them; in this case the invention also provides that the strip-sealing gate is used for sealing a first space having a first process medium relative to a second space having a second process medium that is different from the first process medium.

The embodiments of the invention are shown in the drawings. Therein:

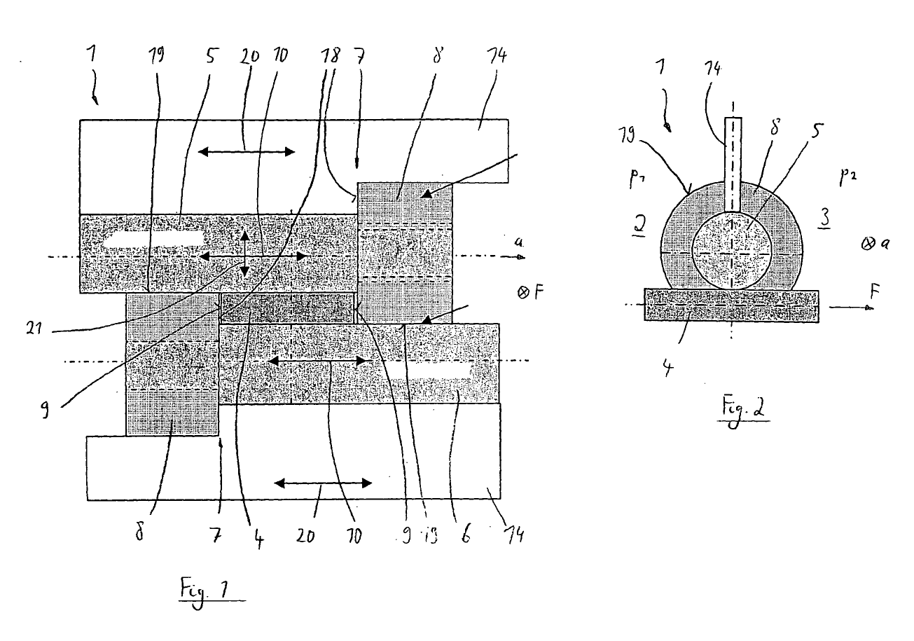

FIG. 1 shows two rollers as the core piece of a roller gate, having seal rollers axially provided on the end for sealing a strip viewed in the travel direction of the strip,

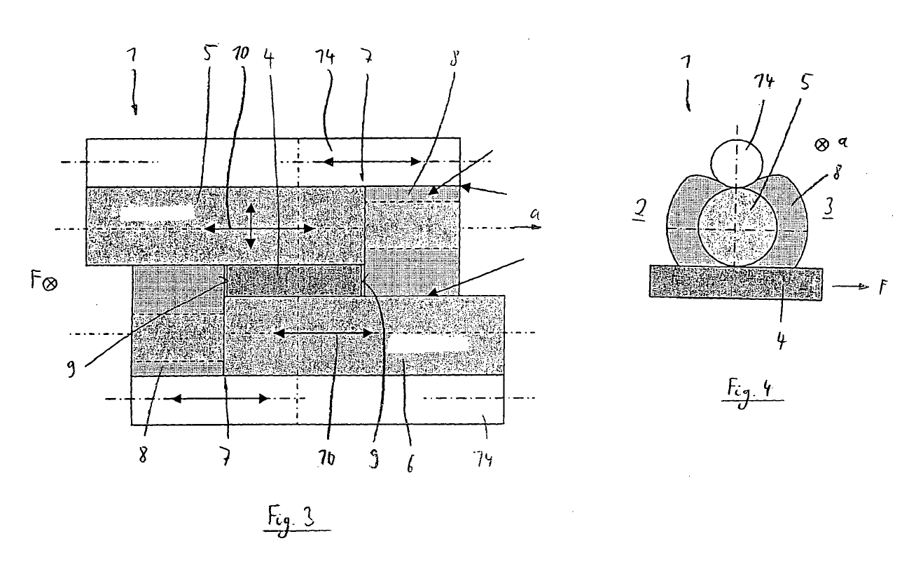

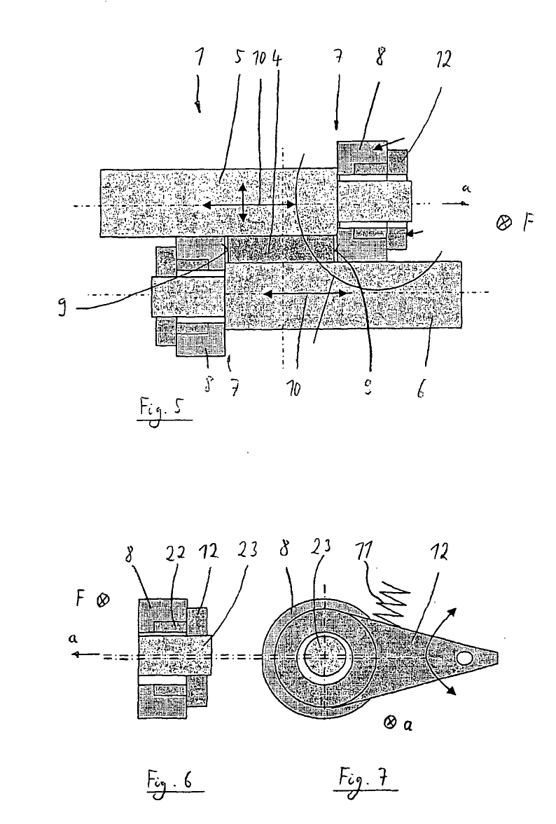

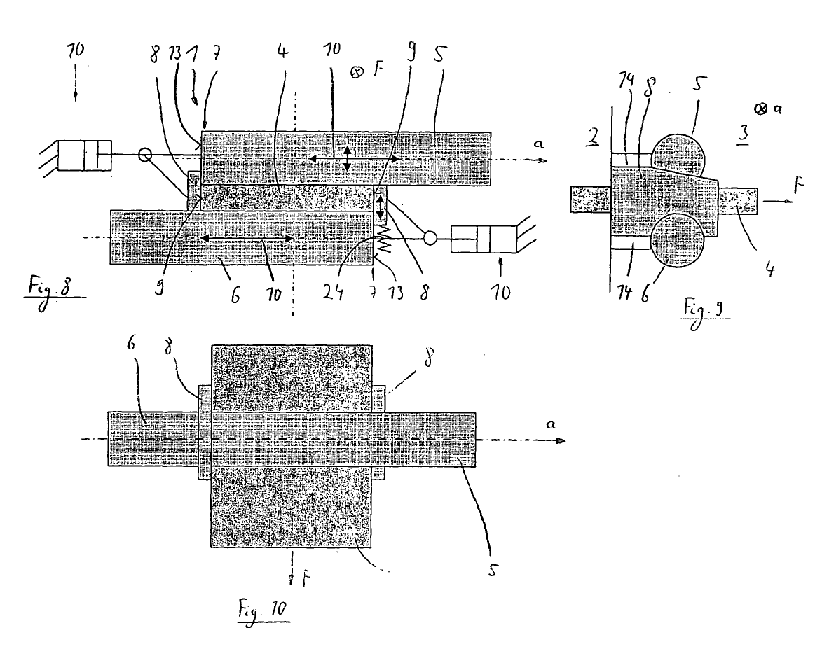

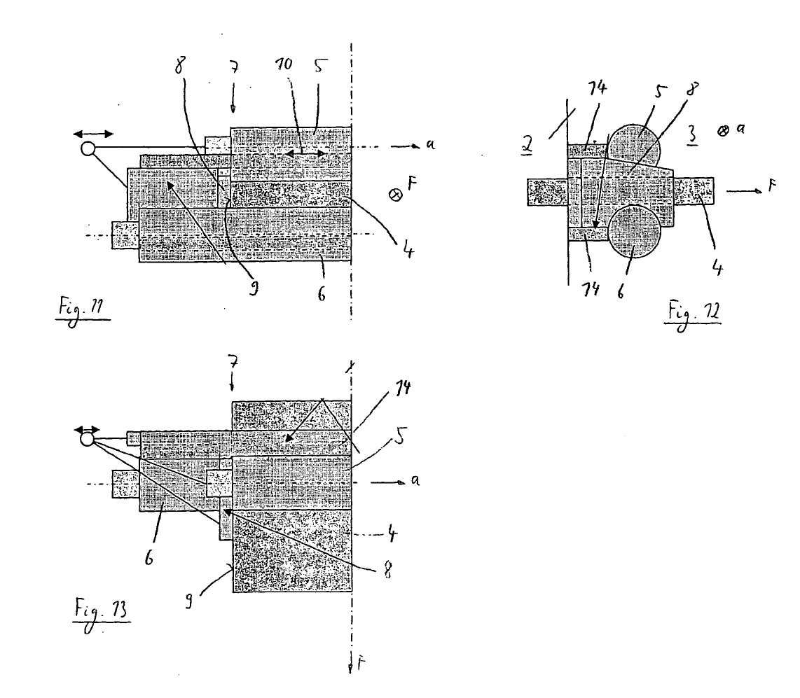

FIG. 2 shows the upper part of the arrangement according to FIG. 1 viewed axially,

FIG. 3 shows an alternative embodiment of the strip-sealing gate of FIG. 1,

FIG. 4 shows the upper part of the arrangement according to FIG. 3 viewed axially,

FIG. 5 shows a further embodiment of the strip-sealing gate as an alternative to FIG. 1,

FIG. 6 shows the end of the journal of the roller according to FIG. 5, having a seal roller that is held by a rocker viewed in the travel direction of the strip,

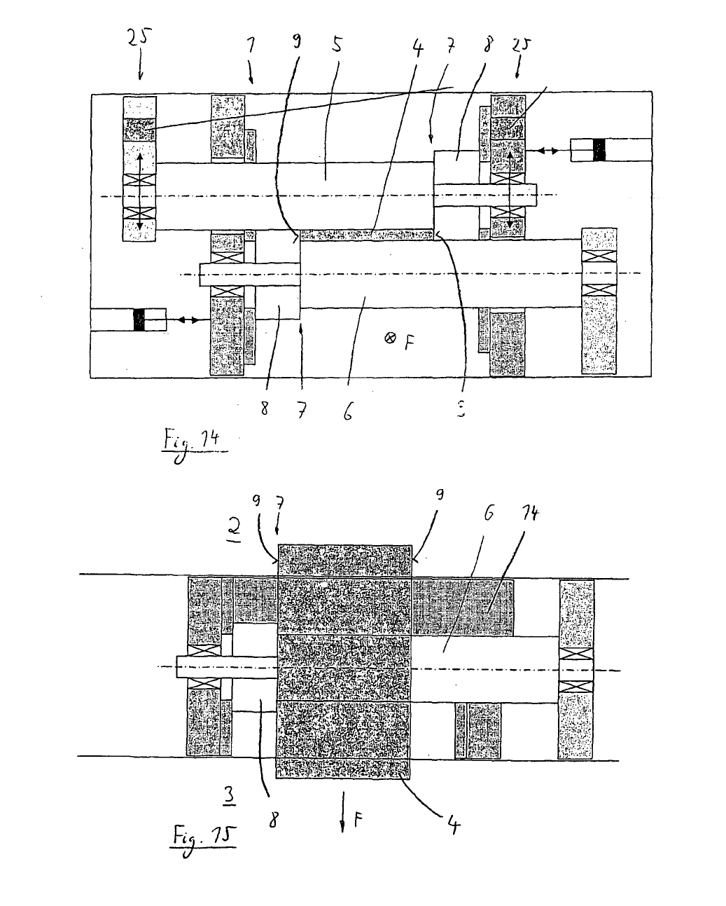

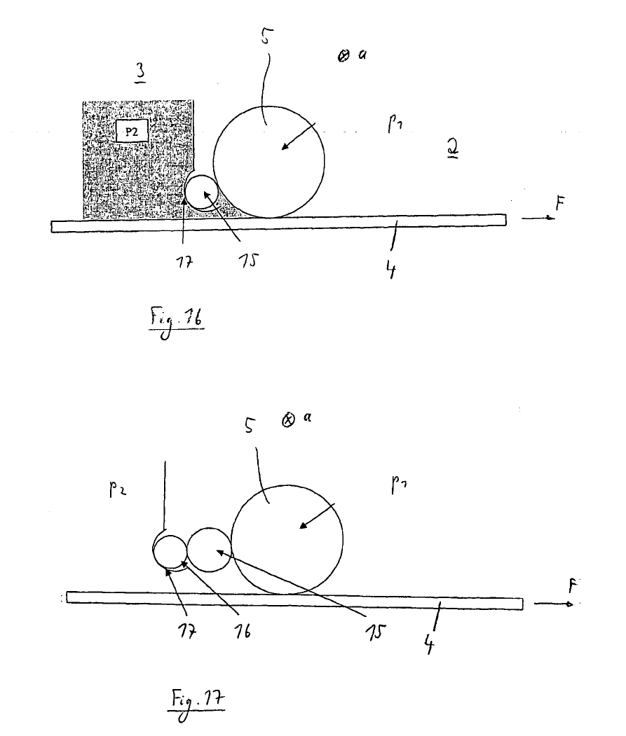

FIG. 7 is a view corresponding to FIG. 6, particularly of the rocker viewed axially,

FIG. 8 shows a further embodiment of the strip-sealing gate as an alternative to FIG. 1,

FIG. 9 is the arrangement according to FIG. 8 viewed axially,

FIG. 10 is the arrangement according to FIG. 8 in a top view,

FIG. 11 shows an embodiment of the strip-sealing gate (only half is shown) as an alternative to FIG. 8 viewed in the travel direction of the strip,

FIG. 12 is the arrangement according to FIG. 11 viewed axially,

FIG. 13 is the arrangement according to FIG. 11 in a top view,

FIG. 14 shows a further embodiment of the strip-sealing gate as an alternative to FIG. 8 viewed in the travel direction of the strip,

FIG. 15 is the arrangement according to FIG. 14 in top view,

FIG. 16 shows a roller above the strip to be sealed, having a upstream seal roller and viewed axially, and

FIG. 17 shows an embodiment of the roller as an alternative to FIG. 16, having two upstream seal rollers and viewed axially.

FIGS. 1 and 2 illustrate a strip-sealing gate 1 through which a strip 4 continuously passes in a travel direction F. Different pressures p₁ and p₂ are in the spaces 2 and 3 upstream and downstream of the strip-sealing gate 1. The strip-sealing gate 1 maintains the pressure differential between the two pressures even during continuous operation. The strip-sealing gate 1 has two rollers 5 and 6 that form the seal, that engage the upper and lower faces of the strip, and that ensure a sealing action on the faces of the strip 4.

In order to create a sealing action particularly at the edges 9 of the strip 4, the invention proposes the embodiment of the strip-sealing gate 1 shown in FIGS. 1 and 2.

In order to seal the surface area, the roller 5 engages, as mentioned, the upper face of the strip 4 and the roller 6 engages the lower face of the strip 4. The rollers 5 and 6 may be steel rollers. It is also conceivable that the roller surface is coated with an effective sealing material, such as with a rubber-like mass that is flexible and elastic.

A seal 8 in the form of a seal roller is provided at one of the axial ends 7 of each of the rollers 5 and 6. To this end, the seal roller 8 has a cylindrical shape such that it may flatly engage the respective strip edge 9 with its end face 18. Each seal roller 8 engages the opposite roller 6 or 5 at the cylindrical outer surface 19 thereof. To this end, each seal roller 9 is firmly axially connected to the respective roller 5 or 6. Preferably the seal rollers each at least one jacket consisting of an elastic material, such as rubber.

The rollers 5 and 6 in turn are each connected to a positioning element 10 that is shown only very schematically, that constitutes positioning means that can adjust the axial position of the respective roller 5 and 6, and thus of the seal roller 8.

As obvious from FIG. 1 the rollers 5 and 6, together with their seal rollers 8, are axially positioned by the respective positioning means 10 such that the axial ends 7 of the rollers 5 and 6 are exactly positioned at axial strip edges 9. This results in the fact that with appropriate selection of diameter of the seal rollers 8 a strip 4 having a rectangular cross-section can be surrounded or enclosed by the two rollers 5 and 6 and by the two laterally offset seal rollers 8 such that a reliable sealing action around the strip 4 is ensured.

Further sealing of the system consisting of the rollers 5 and 6 and the seal rollers 8 toward the upper face and toward the lower face is carried out by seals 14 that are formed according to the shape shown in FIG. 1 and engage the rollers 5 and 6 and the seal rollers 8 such that a sealing action is ensured insofar with regard to a chamber wall that is not shown. As also indicated by the double arrow 20 in FIG. 1 in the area of the seals 14, the seals 14 are moved on the axial positioning jointly with the rollers 5 and 6 and the respective seal rollers 8.

Using the described adjustment movements, strips having different widths and thicknesses can be sealed without any problems, and adjustment to a new strip geometry can be carried out quickly. Adjustment to different strip thicknesses is carried out by movement of the upper roller 5 in the direction of the double arrow 21. If the seal roller 8 is made from an elastic material, or at least has a jacket made of such material, respectively, a certain spectrum of strip thicknesses can then be sealed due to the flexibility of the seal roller 8.

The positioning means 10 can be embodied as hydraulically or mechanically operating elements (such as spindle lifting elements).

The seal roller 8 may be supported on the journal of the roller 5 and 6 so as to be able to rotate freely. In this manner wear and tear is reduced to a minimum in that a balance of the relative movements is possible.

The solution according to FIGS. 3 and 4 differs from that according to FIGS. 1 and 2 in that a roller is used as the seal 14. It has a cylindrical shape and a constant diameter across the entire width of the strip-sealing gate shown in FIG. 3. Accordingly, it must as shown in FIG. 4 press into the elastic material of the seal roller 8, so that a good sealing action is achieved between the seal roller 8 and the seal 14.

FIGS. 5 to 7 show an alternate solution where the seal rollers 8 are each supported in a spring-loaded rocker. The rockers 12 are provided at the ends of the roller 5 and 6 and the respective seal rollers 8 (see particularly FIG. 6), and hold the respective seal roller 8 via sleeves 22. As seen in FIG. 7, each rocker 12 is biased by a spring 11 such that the respective seal roller 8 can be pressed with a radial play relative to the respective roller 5 and 6 against the respective strip edge (see shown eccentricity between the journal 23 of the roller 5 and 6 and the seal roller 8 in FIGS. 6 and 7). The range of motion of the rocker 12, and thus also of the respective seal roller 8 is indicated by the double arrow in FIG. 7.

Sealing at the strip edge is therefore carried out via a rocker supported, rotating collar in this case. The collar maintains constant contact to the counter roller in the adjustment area of the respective roller 5 and 6. Biasing can be done either actively or passively (such as via a spring).

FIGS. 8 to 10 show a further alternate embodiment of the invention. In this case laterally displaceable seal plates 8 are used as the seals.

To this end, the seal plates 8 are positioned such that they contact not only the strip edge 9, but also the end 13 of the other roller 5 and 6. In addition to the denotation of the double arrow with the reference numeral 10, the positioning means are also indicated as piston cylinder systems in FIG. 8. In this case as seen in FIG. 9 the seals 14 are provided in the upstream of the respective rollers 5 and 6.

In this case the sealing of the strip edge 9 is therefore carried out by the seal plates 8. The strip edge 9 and the seal plate 8 are shaped complementarily. The sealing plates are jointly (synchronously) axial displaced with the rollers 5 and 6.

In case of changes to the strip thickness the seal positioned opposite the respective roller can also be actively or passively (using a spring 24) displaced. Contact must be maintained with the outer surface of the facing roller.

A further alternate embodiment of the strip-sealing gate is shown in FIGS. 11 to 13, this solution being similar to that according to FIGS. 8 to 10. The seal formed as a seal plate 8 may also be configured in several parts.

The embodiment according to FIGS. 14 and 15 illustrates a system for adjustment to the thickness of the strip 4. In this case seal rollers 8 are used as the seals.

FIG. 16 shows how an upstream sealing of the strip-sealing gate 1 can be effected. In this case the roller 5 engages a seal roller 15 that extends parallel to the axis a along the full length of the roller 5. The seal roller 15 in turn engages a sealing surface 17 that has a concave surface corresponding to the shape of the seal roller 15. The surface represents a sliding surface, or a slide bearing.

The roller 5 sealing the process space is also pressed against a stationary seal roller 15. In combination with the supporting sliding surface 17 it forms the seal in the rear space area.

Finally, FIG. 17 shows that the principle may also used accordingly, if two seal rollers 15 and 16 are used. In this case the seal roller 15 may be configured as a flexible seal roller. It is sealed on the upstream side by a stationary seal roller 16. In combination with the supporting sliding surface 17 the seal roller 16 forms the seal in the rear space area.

Using the solution provided, spaces having different pressures, but also spaces having the same pressure, may be sealed from each other that contain different process media, particularly process gases, but also liquids. In case lateral rollers engaging the strip edge are provided, a good lateral guide of the strip can be achieved using them. Rollers running on the strip surface can be used for guiding panel elements.

### LIST OF REFERENCE SYMBOLS

| | |
|---|---|
| 1 | strip-sealing gate |
| 2 | first space |
| 3 | second space |
| 4 | strip |
| 5 | roller |
| 6 | roller |
| 7 | axial end |
| 8 | seal (seal roller; seal |
| | plate) |
| 9 | strip edge |
| 10 | adjusting means |
| 11 | spring |
| 12 | rocker |
| 13 | end |
| 14 | seal |
| 15 | seal roller |
| 16 | seal roller |
| 17 | sealing surface |
| 18 | end |
| 19 | cylindrical area |
| 20 | double arrow |
| 21 | double arrow |
| 22 | sleeve |
| 23 | journal |
| 24 | spring |
| 25 | adjoining system |
| a | axial direction |
| F | conveying direction |
| p₁ | first pressure |
| p₂ | second pressure |

1. A strip-sealing gate for sealing a first space relative to a second space through both of which passes a metal strip, at least two rollers provided for sealing the spaces engaging the strip on both faces thereof wherein at least one of the rollers has at one of its axial ends a seal configured to laterally engage an edge of the strip, positioning means being provided that can shift the roller and the seal parallel to the roller axis.

2. The strip-sealing gate according to claim 1 wherein each of the rollers is provided with a seal at each of its axially opposite ends.

3. The strip-sealing gate according to claims 1 wherein the seals are seal rollers.

4. The strip-sealing gate according to claim 3 wherein the seal rollers each consist at least partially of a flexible, elastic material.

5. The strip-sealing gate according to claim 3 wherein the seal rollers at the axial ends of the rollers are each supported in a rocker that is biased by a spring.

6. The strip-sealing gate according to claim 1 wherein the seal is a plate.

7. The strip-sealing gate according to claim 6 wherein the seal plate engages the end of the opposite roller.

8. The strip-sealing gate according to claim 1 wherein a seal is provided on the one roller.

9. The strip-sealing gate according to claim 8 wherein the seal is a strip.

10. The strip-sealing gate according to claim 8 wherein the seal is a roller.

11. The strip-sealing gate according to claim 1 wherein the one roller engages at least one seal roller that is arranged on the same strip face.

12. The strip-sealing gate according to claim 11 wherein the seal roller engages a further seal roller.

13. The strip-sealing gate according to claim 11 wherein at least one of the seal rollers engages a sealing surface.

14. The strip-sealing gate according to claim 13 the sealing surface is concave and is complementarily shaped to the seal roller it engages.

15. The strip-sealing gate according to claim 1 wherein multiple gate stages are arranged successively in the strip travel direction.

16. The strip-sealing gate according to claim 1 wherein the gate is used for sealing a first space at a first pressure relative to a second space at a second pressure different from the first pressure.

17. The strip-sealing gate according to claim 1 wherein the gate is used for sealing a first space having a first process medium relative to a second space having a second process medium different from the first process medium.
